(19) United States
(12) Patent Application Publication
(10) Pub. No.: US 2025/0277965 A1
(43) Pub. Date: Sep. 4, 2025

(54) MODULE INTENDED TO BE ASSOCIATED WITH A MICROSCOPE, AND ASSEMBLY FORMED BY A MICROSCOPE AND SUCH A MODULE

(71) Applicants: SORBONNE UNIVERSITE, Paris (FR); CENTRE NATIONAL DE LA RECHERCHE SCIENTIFIQUE, Paris (FR); INSTITUT NATIONAL DE LA SANTE ET DE LA RECHERCHE MEDICALE-INSERM, Paris (FR); ECOLE SUPERIEURE DE PHYSIQUE ET DE CHIME INDUSTRIELLES DE LA VILLE DE PARIS, Paris (FR); CENTRE HOSPITALIER NATIONAL D'OPHTALMOLOGIE QUINZE-VINGTS, Paris (FR)

(72) Inventors: Kate GRIEVE, Paris (FR); Olivier THOUVENIN, Paris (FR); Tual MONFORT, Paris (FR); Salvatore AZZOLLINI, Paris (FR); Sacha REICHMAN, Paris (FR)

(73) Assignees: SORBONNE UNIVERSITE, Paris (FR); CENTRE NATIONAL DE LA RECHERCHE SCIENTIFIQUE, Paris (FR); INSTITUT NATIONAL DE LA SANTE ET DE LA RECHERCHE MEDICALE-INSERM, Paris (FR); ECOLE SUPERIEURE DE PHYSIQUE ET DE CHIME INDUSTRIELLES DE LA VILLE DE PARIS, Paris (FR); CENTRE HOSPITALIER NATIONAL D'OPHTALMOLOGIE QUINZE-VINGTS, Paris (FR)

(21) Appl. No.: 18/858,589

(22) PCT Filed: Apr. 22, 2022
(86) PCT No.: PCT/FR2022/000042

§ 371 Date: Oct. 21, 2024

(51) Int. Cl. G02B 21/18; G02B 21/02; G02B 21/24; G02B 21/26

(52) U.S. Cl. CPC G02B 21/18; G02B 21/02; G02B 21/248; G02B 21/26

(57) ABSTRACT

The invention relates to a module intended to be associated with a microscope for full-field optical coherence tomography microscopic imaging of at least one sample, the module comprising an interference device (4) comprising a non-polarising beam splitter element (10) for forming two arms when it is illuminated by a source, namely a “reference arm” associated with the reflection surface and an “object arm” associated with the sample, the device furthermore comprising:
a first adjustment unit (11) arranged upstream of the non-polarising beam splitter element for allowing an illumination arm of the non-polarising beam splitter element to be modified during operation, and/or
at least one second adjustment unit (18) arranged between the beam splitter element and the reflection surface for allowing the reference arm to be modified during operation.

The invention relates to a module intended to be associated with a microscope for the full-field optical coherence tomography microscopic imaging of at least one sample.

The invention also relates to an assembly formed by a module of this kind and a microscope.

### BACKGROUND OF THE INVENTION

The recent emergence of three-dimensional cell culture technology allows human physiology to be emulated more precisely by comparison with traditional two-dimensional cell culture, on which a large number of pharmaceutical developments and other biomedical applications (tissue transplants, etc.) are currently based.

In this field, the recent emergence of organoid technology is particularly promising since it makes it possible to overcome at least some of the issues related to creating three-dimensional human tissue, replicating in particular the physiological conditions in vivo. In addition, this organoid technology makes it possible to indefinitely produce material that can be described as “human” without any ethical constraints and could therefore, in the long term, lead to fewer studies on animal models or no such studies at all. Organoids can thus be used for disease modelling, to test the effectiveness of new treatments (genetics, pharmaceuticals, etc.), for transplants, etc. However, while organoid technology has matured, it remains difficult to perform control imaging with sufficient precision and in a non-destructive manner, to check the proper functioning of said organoids. Specifically, conventional imaging techniques require fixation of the samples, i.e. the samples have to be destroyed or irreversibly altered, which leads to a nonfactual analysis and may result in biased decision-making. In addition, conventional imaging techniques require multiplication of the samples (and therefore additional costs), bring about additional variability in the results and do not make it possible to check the viability and quality of a transplanted sample.

Furthermore, the current state of the art does not make it possible to perform three-dimensional control imaging that is sufficiently quantitative to ensure a particular level of cellular or subcellular precision. Optical coherence tomography (OCT) imaging allows images to be acquired with greater precision. For this purpose, full-field optical coherence tomography imaging is based on acquiring signals originating from interference between a signal of a light backscattered by a sample when it is illuminated by a source and a reference light signal emitted by that source. Document FR 2 817 030 describes an example of a full-field optical coherence interferential microscopic imaging system.

Unfortunately, the use of these systems is not very widespread because of their complexity and cost.

### OBJECT OF THE INVENTION

The object of the invention is in particular to enable the full-field optical coherence tomography microscopic imaging of at least one sample, said imaging being simple to implement.

### SUMMARY OF THE INVENTION

To this end, according to the invention, a module is provided which is intended to be associated with a microscope for the full-field optical coherence tomography microscopic imaging of at least one sample, the module comprising an interference device comprising a non-polarising beam splitter element, the device further comprising a reflection surface, the device thus being capable, during operation, of allowing at least one interference to be produced between:
at least one reference wave obtained by reflecting the light emitted by a light source associated with the module on the reflection surface and.
at least one object wave obtained by backscattering the light emitted by said source onto the sample,
the non-polarising beam splitter element thus making it possible, during operation, when it is illuminated by the source, to form two arms, namely a “reference arm” associated with the reflection surface and an “object arm” associated with the sample, the device further comprising:
a first adjustment unit arranged upstream of the non-polarising beam splitter element for allowing an illumination arm of the non-polarising beam splitter element to be modified during operation, and/or
at least one second adjustment unit arranged between the beam splitter element and the reflection surface for allowing the reference arm to be modified during operation.

As a result, the invention can be coupled to an existing microscope in order to perform full-field optical coherence tomography microscopic imaging. It is sufficient to associate the invention with the microscope and then to use the adjustment unit(s) to ensure the interference between the reference waves and the object waves.

For example, the second unit is adjusted such that the reference arm is identical to the object arm, i.e. the optical paths in the two arms are identical (to the spatial coherence length of the source) when the microscope is coupled to the module.

For example, the first unit is adjusted so as to align a working axis of the module (i.e. the axis along which the majority of the light rays propagating on the object arm exit the module to reach the microscope) with a propagation axis of the source (i.e. the axis along which the majority of the light rays generated by the source propagate) during operation.

Thus, the use of such optical coherence tomography microscopic imaging is made simpler for users since they are already used to working with the associated microscope.

In addition, once the invention has been coupled to the microscope and adjusted, anyone used to using the microscope can benefit from the advantages of the invention without having to touch it. Consequently, the invention provides simpler access to full-field optical coherence tomography microscopic imaging.

Advantageously, it is thus possible to couple the invention to a conventional microscope, i.e. a pre-existing microscope on the market, by connecting the invention to said microscope and then adjusting it thereto.

This again provides simpler access to full-field optical coherence tomography microscopic imaging, and in particular to full-field optical coherence tomography microscopic imaging in combination with a conventional microscope (since users no longer have to concern themselves with the invention once it has been coupled to the microscope).

In addition, the invention expediently makes it possible to benefit from the advantages of a conventional microscope such as special imaging characteristics (visible light imaging, fluorescence imaging, etc.), special objectives, etc. In particular, the associated microscope may be a microscope for which other optical modules have already been developed, for instance differential interference contrast modules (DIC), coherent anti-Stokes Raman scattering modules (CARS), second harmonic generation modules (SHG), third harmonic generation modules (THG), Raman modules, single-photon or two-photon fluorescence modules, etc. The module of the invention can thus easily be coupled to these prior art modules, thereby making it possible to expand the possibilities for imaging the sample. Furthermore, the associated microscope may be a microscope for which accessories have already been developed, so connecting the invention to such a microscope makes it possible to benefit from the accessories of the microscope.

Since the invention can be connected to a standard microscope, it thus advantageously gives access to many options already developed for that microscope.

Furthermore, the invention allows different types of full-field optical coherence tomography microscopic imaging to be implemented. In particular, the invention can thus allow for both full-field optical coherence tomography (FFOCT) imaging—i.e. so-called “static” imaging—and dynamic full-field optical coherence tomography (D-FFOCT) imaging. Thus, the invention makes it possible, for example, to observe elements present in a sample (static imaging) as well as elements that make up a tissue of one of said structures of that sample (dynamic imaging). The elements may, for example, be cells, structures and in particular subcellular structures such as nuclei, mitochondria, pigments, etc.

The invention can therefore be used for many different applications and/or according to different modes of operation (static imaging or dynamic imaging).

The invention is thus particularly modular.

Furthermore, the invention allows the cost of optical coherence tomography microscopic imaging to be reduced since the invention is added to an existing microscope.

For the purposes of the present invention, the term “reference arm” means the part of the module located between the reflection surface and the non-polarising beam splitter element (a light ray thus being able to propagate in said reference arm along a given optical path).

For the purposes of the present invention, the term “object arm” means the part of an assembly, formed by the module and the microscope, that is located between the sample and the non-polarising beam splitter element (a light ray thus being able to propagate in said object arm along a given optical path).

For the purposes of the present invention, the term “illumination arm” means the part of an assembly, formed by the module and the microscope, that is located between the source and the non-polarising beam splitter element (a light ray thus being able to propagate in said object arm along a given optical path).

For the purposes of the present invention, “modification of a propagation characteristic” means, for example, modification of a relative position of a frame of the module with respect to the source, for example to modify the relative position of the frame with respect to the propagation axis of the source and/or the incidence angle at which the light rays generated by the source reach the non-polarising beam splitter element.

Optionally, the first adjustment unit comprises at least two reflection surfaces, at least one of said reflection surfaces being movable relative to a frame of the module.

Optionally, the module comprises an objective associated with the reference arm, the second adjustment unit comprising at least one additional reflection surface and at least one member for moving said objective relative to a frame of the module.

Optionally, the additional reflection surface is also movable relative to a frame of the module.

Optionally, the movement member is configured to move the objective at least in a plane parallel to the plane in which the first reflection surface extends.

Optionally, the source is part of the module.

Optionally, the module comprises an acquisition device suitable for acquiring at least one signal resulting from the interference between the reference waves and the object waves.

Optionally, the interference device comprises an optic arranged between the splitter element and an output of the module that is intended to be at least optically coupled to the microscope.

The invention also relates to an assembly comprising a microscope and a module as described above.

Optionally, the microscope comprises a turret, the module being arranged in one of the compartments of the turret.

Optionally, the assembly comprises an incubator supported by a stage of the microscope.

Other features and advantages of the invention will become clear on reading the following description of a particular and non-limiting embodiment of the invention.

### BRIEF DESCRIPTION OF THE DRAWING

Reference will be made to the sole accompanying drawing, in which:

FIG. 1 is a diagrammatic view of an assembly formed by a microscope and a module in a particular embodiment of the invention.

### DETAILED DESCRIPTION OF THE INVENTION

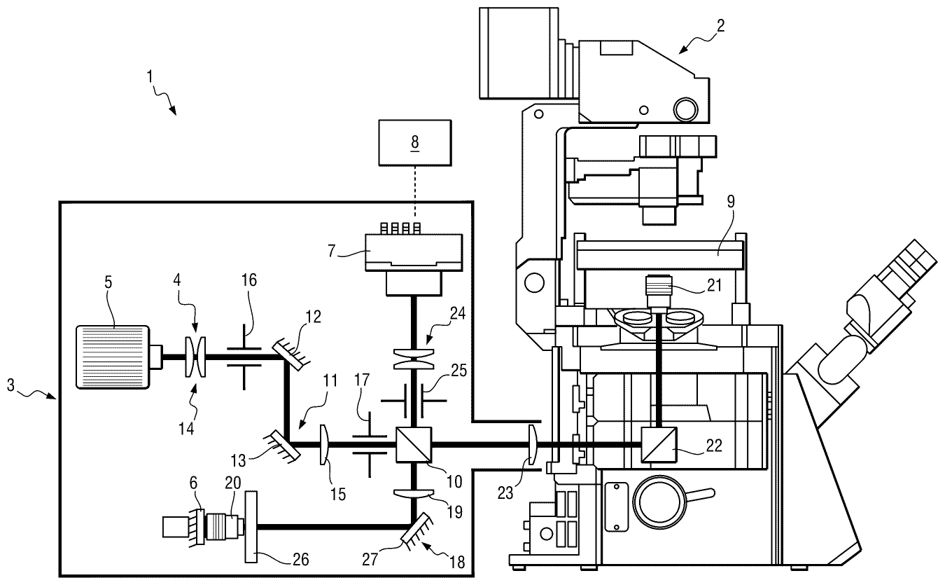

FIG. 1 diagrammatically shows an assembly for the full-field optical coherence tomography microscopic imaging of at least one sample, according to a particular embodiment of the invention.

The assembly 1 thus comprises at least one microscope 2 and a module 3 connected to the microscope 2.

By way of example, the module 3 is shaped so as to be able to be arranged in one of the compartments of the bank of compartments of the microscope 2, said bank forming a turret.

By shaping the module 3 so as to be a module that can be arranged in a compartment of the microscope 2, the module 3 can be coupled to said microscope 2 (both mechanically and optically) in a very simple manner by simply inserting the module 3 into the microscope 2. In particular, the microscope 2 is shaped so as to have at least one optical output facing at least one bank so that the module inserted into said bank is de facto optically coupled to the microscope 2.

The microscope 2 is an inverted microscope, for example. An inverted microscope is a microscope in which a sample is observed from below.

In this case, the microscope is advantageously a conventional microscope. For example, the microscope 2 is an IX83 sold by Olympus.

In a manner known per se, the microscope 2 comprises a stage intended for supporting a sample to be observed, the stage being movable in translation relative to a frame of the microscope 2 along at least two translation axes.

As mentioned above, the microscope also comprises a turret for inserting modules to interact with the microscope 2.

The module 3 comprises an interference device 4 which in this case comprises a source 5 and a reflection surface 6, the interference device 4 thus being capable, during operation, of producing optical interference between:
reference waves obtained by reflecting the light emitted by the source 5 on the reflection surface 6 and
object waves obtained by backscattering the light emitted by said source 5 onto the sample.

The source 5 is a spatially incoherent source or one with a short spatial coherence length (for example in a range of 0.5 to 120 micrometres, or for example in a range of 0.8 to 100 micrometres, or for example in a range of 1 to 20 micrometres). The source 5 is, for example, a halogen lamp, a light-emitting diode (LED) or a block formed by a coherent source (the coherent source being a laser, for example) and a structure through which the rays pass at the output of the coherent source, said structure allowing said rays to be made spatially incoherent at the output of the structure (and therefore of the block). By way of example, the structure is provided with a multimode-type cavity, a multimode fibre, a hexagonal rod, etc.

The reflection surface 6 is planar. The reflection surface 6 is a mirror, for example.

In this case, the assembly 1 also comprises an acquisition device 7. In the present case, the acquisition device 7 is part of the module 3. The acquisition device 7 makes it possible to acquire at least one signal resulting from the interference between the reference waves and the object waves.

For this purpose, the acquisition device 7 comprises an optical sensor. The optical sensor is preferably a complementary metal-oxide-semiconductor (CMOS) optical sensor.

Preferably, the optical sensor is selected to acquire images at a high rate. This makes it possible, if so desired, to follow a series of movements within the sample when the sample comprises at least one living cell. For example, the optical sensor is capable of acquiring images at a frequency greater than 100 Hertz, preferably greater than 200 Hertz and preferably greater than 400 Hertz.

Preferably, the optical sensor is selected to acquire images at a high signal-to-noise ratio. This allows the optical sensor to be sensitive even to very small living structures and/or even to very small movements. For example, the optical sensor is capable of acquiring images at a signal-to-noise ratio greater than 500, preferably greater than 800 and preferably greater than 1000.

By way of example, the optical sensor is a camera, e.g. a CMOS camera, for example a Q-2A750 camera or a Q-2HFW camera, both sold by Adimec.

In this case, the assembly 1 also comprises a device 8 for processing the signal emitted by the acquisition device 7 in order, for example, to generate an image of at least one portion of the sample. In the present case, the signal processing device 8 is external to the module 3. The signal processing device 8 comprises at least one processing unit such as a processor. By way of example, the signal processing device 8 comprises a computer.

Preferably, the assembly 1 comprises an incubator 9 for a microscope. By way of example, the incubator 9 is arranged in the microscope 2 so as to be supported by the stage of the microscope 2, the sample being placed directly in the incubator 9.

The incubator 9 is preferably portable so that it can be temporarily connected to the microscope 2.

The incubator 9 allows samples comprising at least one living cell to be studied in a more straightforward manner. Specifically, the incubator 9 allows such samples to be kept alive over several days or even several weeks.

Preferably, the incubator 9 is shaped so as to be able to receive multi-well plates.

Preferably, the incubator 9 is equipped with a temperature control within the incubator 9.

This makes it possible, for example, to prevent the sample heating up due, in particular, to the internal illumination of the microscope 2, which could alter or destroy the sample.

Preferably, the incubator 9 is equipped with a control for the presence of at least one gas in the incubator. For example, the incubator is equipped with a control for the presence of carbon dioxide in the incubator and/or for the presence of nitrogen in the incubator and/or for the presence of oxygen in the incubator.

Where the sample comprises live cells, the incubator 9 is preferably configured to keep the sample at a given temperature, for example at a temperature substantially equal to 37° C. (for example for human, primate or pig cells, etc.). Preferably, the incubator 9 is configured to allow the sample to be oxygenated (in particular by supplying a nitrogen-dioxygen mixture and evacuating the carbon dioxide), this oxygenation being ensured at least by controlling the level of carbon dioxide in the incubator. Preferably, the incubator 9 is configured to allow the humidity level of the sample to be managed so that the sample does not dry out. For example, the incubator 9 is equipped with a sensor for checking that the humidity level in the incubator 9 is between 70 and 100%.

In this case, the incubator 9 is advantageously a conventional incubator. For example, the incubator 9 is an H201-K incubator sold by Okolab.

Coupling the module 3 to a commercial microscope advantageously makes it possible to benefit from pre-existing apparatuses that are capable of cooperating with said microscope, for example portable incubators, without the need to develop new apparatuses. The interference device 4 will now be described.

The interference device 4 comprises a frame supporting a seat that is immovable relative to the frame.

Said seat supports a non-polarising beam splitter (NPBS) element 10. By way of example, the splitter element 10 is a non-polarising splitter cube, a non-polarising splitter plate, etc.

The source 5 is intended for illuminating the splitter element 10. However, the source 5 does not directly illuminate the splitter element 10. The source 5 is thus offset from the splitter element 10 and from the seat. The source 5 is thus fastened to a portion of the frame.

Specifically, the interference device 4 comprises a first adjustment unit 11 by means of which the source 5 illuminates the splitter element 10.

In the present case, the first adjustable unit 11 comprises at least one reflection surface. By way of example, the first adjustment unit 11 comprises at least two reflection surfaces 12, 13 that are mounted facing each other. The reflection surfaces 12, 13 are planar. The reflection surfaces 12, 13 are mirrors, for example.

Typically, the first adjustment unit 11 is arranged such that, during operation, the source 5 directly illuminates one of the reflection surfaces 12, which reflects the light towards the other reflection surface 13, which in turn reflects the light towards the splitter element 10 so as to illuminate it.

At least one reflection surface, preferably both reflection surfaces 12, 13, is mounted to be movable relative to the frame. The first adjustment unit 11 is shaped so that the two reflection surfaces 12, 13 can be moved relative to the frame independently of each other. For example, at least one of the reflection surfaces, preferably both reflection surfaces 12, 13, can pivot relative to the frame. For example, the first adjustment unit 11 comprises a first kinematic mount that supports the reflection surface 12 (and allows said reflection surface 12 to be moved relative to the frame) and a second kinematic mount that supports the reflection surface 13 (and allows said reflection surface 13 to be moved relative to the frame). Owing to the movements of the reflection surfaces 12, 13, it is possible, for example, to modify the optical path of the rays generated by the source 5 up to the splitter element 10.

In particular, the interference device 4 comprises a first optic 14 arranged upstream of the first adjustment unit 11 (the notions of “upstream” and “downstream” being understood in relation to the light flow direction) between the source 5 and the first adjustment unit 11.

The first optic 14 in particular allows the divergence of the rays generated by the source 5 to be reduced. This limits any loss of power in the light radiation generated by the source 5.

By way of example, the first optic 14 is a single lens, a single doublet or a pair of lenses or a pair of doublets. Where the first optic 14 is a pair of doublets, the first optic 14 is composed, for example, of a first achromatic doublet (i.e. an assembly formed by an achromatic convergent lens and an infinitely corrected planar lens upstream) and a second achromatic doublet (i.e. an assembly formed by an achromatic convergent lens and an infinitely corrected planar lens downstream), the second doublet being arranged downstream of the first doublet. The flat faces of the lenses face the source 5 and the adjustment unit 11, respectively.

The interference device 4 comprises a second optic 15 arranged downstream of the first adjustment unit 11 between the first adjustment unit 11 and the splitter element 10. By way of example, the second optic 15 is a lens, a doublet, etc. For example, the second optic 15 is an achromatic doublet comprising an achromatic convergent lens, preferably an achromatic convergent lens having a flat face that faces the first adjustment unit 11.

According to a particular embodiment, the interference device 4 comprises a first diaphragm 16 arranged upstream of the first adjustment unit 11 between the source 5 and the first adjustment unit 11. By way of example, the first diaphragm 16 is arranged downstream of the first optic 14 between the first optic 14 and the first adjustment unit 11.

By way of example, the first diaphragm 16 is an aperture diaphragm. The first diaphragm 16 is arranged in a focal plane of the second doublet of the first optic 14, preferably in the image focal plane of the second doublet of the first optic 14.

Thus, the first optic 14 images the source 5 at the image focal plane of said second doublet, which coincides with the first diaphragm 16.

It is noted that the source 5 is conjugated to the first diaphragm 16 by means of the first optic 14.

Therefore, by way of its aperture, the first diaphragm 16 makes it possible, for example, to control the degree of spatial incoherence of the source 5 and/or the amount of light received by the sample and/or the illumination numerical aperture of the assembly 1. Moreover, the first diaphragm 16 is arranged in a focal plane of the second optic 15, preferably in the object focal plane of the second optic 15.

Furthermore, the focal length of the second optic 15 must be less than or equal to the distance between the first optic 14 and the first diaphragm 16.

For the purposes of the present description, the term “diaphragm” means any member for controlling the passage of the light radiation generated by the source 5: an iris diaphragm, a hole in a dedicated wall, etc.

According to a particular embodiment, the interference device 4 comprises a second diaphragm 17 arranged downstream of the first adjustment unit 11 between the first adjustment unit 11 and the splitter element 10. By way of example, the second diaphragm 17 is arranged downstream of the second optic 15 between the second optic 15 and the second splitter element 10.

The second diaphragm 17 is a field diaphragm.

The second diaphragm 17 makes it possible to restrict the illumination of the sample so as to illuminate only the portion of the sample that will be imaged by the assembly 1, and/or to reduce incoherent reflections.

In the example shown in the sole figure, the source 5, the first optic 14, the first diaphragm 16, the first adjustment unit 11, the second optic 15 and the second diaphragm 17 are thus located one after the other upstream of the splitter element 10. The first optic 14, the first diaphragm 16, the second optic 15 and the second diaphragm 17 are fastened in the module 3.

By way of example, the second optic 15 and the second diaphragm 17 are supported by the seat. Typically, the second optic 15 and the second diaphragm 17 are arranged in line with the splitter element 10.

Preferably, the source 5, the first optic 14 and the first diaphragm 16 are supported by the same portion of the frame, in a manner offset from the seat.

The source 5 therefore illuminates the splitter element 10, thereby allowing an “illumination arm” of said splitter element 10 to be defined.

Furthermore, it is known that the splitter element 10, once it has been illuminated by the source, allows two arms to be formed:
a “reference arm” which is associated with the reflection surface 6,
an “object arm” which is associated with the sample when in operation.

The source 5 is therefore on neither the object arm nor the reference arm but on the illumination arm.

By contrast, the reflection surface 6 is on the reference arm. The interference device 4 also comprises a second adjustment unit 18 by means of which the reflection surface 6 can interact with rays propagating from the splitter element 10 on the reference arm.

Typically, the second adjustable unit 18 comprises at least one reflection surface 27. In particular, the second adjustment unit 18 is arranged such that, during operation, a ray from the splitter element 10 is reflected on the reflection surface 27 to reach the reflection surface 6.

The reflection surface 27 is planar. The reflection surface 27 is a mirror, for example.

Preferably, said reflection surface 27 is mounted so as to be movable relative to the frame of the module 3. By way of example, the reflection surfaces 27 can pivot relative to the frame. For example, the second adjustment unit 18 comprises a kinematic mount that supports the reflection surface 27 (and allows said reflection surface 27 to be moved relative to the frame).

Owing to the movements of the reflection surface 27, it is thus possible to modify the optical path of the rays reflected by the reflection surface 6 up to the beam splitter element 10.

Preferably, the reflection surface 6 is itself mounted in the interference device 4 so as to be movable relative to the frame, so that it can be moved relative to the sample while the sample is being studied. By way of example, the reflection surface 6 is mounted on a base that is movable in translation relative to the frame. For example, the base can be moved in translation relative to the frame by means of at least one piezoelectric actuator. For example, the base can be moved in translation in parallel with the optical axis of the source 5 but not coincident therewith.

In this case, the interference device 4 comprises a third optic 19 arranged between the splitter element 10 and the reflection surface 6. By way of example, the third optic 19 is a lens, a doublet, etc. For example, the third optic 19 is an achromatic doublet comprising an achromatic convergent lens, preferably an achromatic convergent lens having a flat face that faces the splitter element 10.

The third optic 19 makes it possible, for example, to simplify balancing between the object arm and the reference arm and/or to properly illuminate the reflection surface 27 (i.e. over a wide field). Furthermore, the assembly 1 comprises a first objective 20 and a second objective 21. The two objectives 20, 21 are identical and are each associated with one of the arms. Both objectives have the same numerical aperture (NA).

Optionally, the numerical aperture of the objectives is high. For the purposes of the present application, the term “high” means a numerical aperture greater than 0.8, preferably greater than 1.

It is noted that the second optic 15 allows the source 5 to be imaged on a focal plane of the two objectives, for example on the object focal plane of the two objectives 20, 21.

The first objective 20 is part of the module 3 and, in this case, of the interference device 4. Thus, the first objective 20 is arranged in the module 3 at the reflection surface 6. By way of example, the optical axis of the first objective 20 is normal to a plane in which the reflection surface 6 extends.

More precisely, in this case, the first objective 20 is arranged such that the reflection surface 6 is located in one of the foci of the first objective, for example at the secondary focus of the first objective 20. The first objective 20 is therefore on the reference arm.

Preferably, the second adjustment unit 18 also comprises a member 26 for moving the first objective 20 relative to the frame, in particular relative to the reflection surface 6. By way of example, the first objective 20 is supported by an underframe that is moved by means of the movement member. For example, the movement member is configured to be able to move the first objective 20 along at least two translation axes. For example, the movement member is configured to be able to move the first objective 20 at least in a plane normal to the axis along which the reflection surface 6 can be moved relative to the frame.

In the example shown in the sole figure, the third optic 19, the second adjustment unit 18, the first objective 20 (associated with the movement member 26) and the reflection surface 6 are thus located one after the other downstream of the splitter element 10, on the reference arm side.

Furthermore, the second objective 21 is not part of the module 3. In reality, the second objective 21 is directly the objective (or one of the objectives) of the microscope 2.

The sample is intended to be positioned at one of the foci of the second objective 21, for example at the secondary focus of the second objective 21.

As a result, the second objective 21 is on the object arm when the microscope 2 and the module 3 are coupled. It is therefore clear that because the second objective 21 is that of the microscope, the module 3 alone cannot be sufficient to form a complete interferometer.

Since the microscope 2 is an inverted microscope, the second objective 21 is arranged so as to observe the sample from below the sample. By way of example, the second objective 21 is arranged under the stage and, in the present case, under the incubator 9.

In a manner known per se, the microscope 2 comprises a reflection surface 22 such that a ray passing through the second objective 21 along the optical axis of said second objective 21 can be reflected as far as the optical output of the microscope 2.

Typically, the reflection surface 22 is planar. For example, the reflection surface 22 is a mirror, for example a thick mirror, for example a mirror having a thickness greater than or equal to 3 millimetres, for example a thickness greater than or equal to 4 millimetres. Preferably, said reflection surface 22 is a planar mirror supported by a prism or a planar mirror supported by a cube.

In the present case, said reflection surface 22 is arranged such that a ray propagating along the optical axis of the second objective 21 is then propagated, after being reflected on the reflection surface 22, to exit via the optical output of the microscope 2. When the module 3 is connected to the microscope 2, a ray of this kind thus propagates from said output to the splitter element 10 along the object arm.

The interference device 4 also comprises a fourth optic 23 arranged between the splitter element 10 and an “object arm” output of the module, i.e. the module output at least optically coupled to the optical output of the microscope 2. By way of example, the fourth optic 23 is a lens, a doublet, etc. For example, the fourth optic 23 is an achromatic doublet comprising an achromatic convergent lens, preferably an achromatic convergent lens having a flat face that faces the splitter element 10. Preferably, the fourth optic 23 is associated with at least one member for moving the fourth optic 23 relative to the frame, in particular relative to the splitter element 10 (in particular for moving the fourth optic 23 towards or away from the splitter element 10). By way of example, the fourth optic 23 is supported by an underframe that is moved by means of the movement member. For example, the movement member is configured to move the fourth optic 23 in at least one translation. For example, the movement member is configured to move the fourth optic 23 in at least one translation along the working axis of the module (i.e. the axis along which the majority of the light rays propagating on the object arm exit the module to reach the microscope).

Preferably, the fourth optic 23 is arranged in the module so as to be placed as close as possible to the reflection surface 22. Thus, the fourth optic 23 is preferably arranged such that the distance between the second objective 21 and the fourth optic 23 is equal to the focal distance of said fourth optic 23.

This prevents the source being non-homogeneously illuminated. In addition, this limits any loss of power in the light radiation generated by the source 5 at the sample.

The third optic 19 is arranged such that a focal plane of the third optic 19 coincides with a focal plane of the first objective 20, for example such that the image focal plane of the third optic 19 coincides with the object focal plane of the first objective 20.

The fourth optic 23 is arranged such that a focal plane of the fourth optic 23 coincides with a focal plane of the second objective 21, for example such that the image focal plane of the fourth optic 23 coincides with the object focal plane of the second objective 21.

Preferably, the second diaphragm 17 is arranged in a focal plane of the fourth optic 23 by means of the splitter element 10, for example in the object focal plane of the fourth optic 23. Thus, the second diaphragm 17 is conjugated to the sample by means of the second objective 21 (the sample being at a focus of the second objective 21, for example at the secondary focus of the second objective).

Preferably, the second diaphragm 17 is arranged in a focal plane of the third optic 19 by means of the splitter element 10, for example in the object focal plane of the third optic 19.

To make the object arm and reference arm symmetrical, the third optic 19 and the fourth optic 23 must be arranged identically with respect to the splitter element 10.

In addition, the module 3 comprises a fifth optic 24 arranged at the output of the interference device 4, i.e. arranged between the splitter element 10 and the acquisition device 7. The fifth optic 24 may be part of the interference device 4 or may not be part of said interference device 4.

By way of example, the fifth optic 24 is a single lens, a single doublet or a pair of lenses or a pair of doublets. Where the fifth optic 24 is a pair of doublets, the fifth optic 24 is composed, for example, of a first achromatic doublet (i.e. an assembly formed by an achromatic convergent lens and an infinitely corrected planar lens upstream) and a second achromatic doublet (i.e. an assembly formed by an achromatic convergent lens and an infinitely corrected planar lens downstream), the second doublet being arranged downstream of the first doublet. The flat faces of the lenses face the acquisition device 7 and the splitter element 10, respectively.

The fifth optic 24 is arranged to conjugate the planes located at the foci of the two objectives 20, 21 (for example the planes located at the secondary foci of the two objectives 20, 21) in the same plane at the output of the interference device 4. Preferably, the optical sensor of the acquisition device 7 is placed in this latter plane. The optical sensor is thus arranged in a focal plane of the fifth optic 24, for example in the image focal plane of the fifth optic 24.

Preferably, a focal plane of the fourth optic 23 is conjugated to a focal plane of the fifth optic 24, for example an image focal plane of the fourth optic 23 is conjugated to the object focal plane of the fifth optic 24.

Preferably, the interference device 4 comprises a third diaphragm 25 arranged upstream of the fifth optic 24, between the fifth optic 24 and the splitter element 10. The third diaphragm 25 is a field diaphragm.

This third diaphragm allows the optical position of the optical sensor to be adjusted and, for example, incoherent reflections to be reduced.

The second diaphragm 17 is thus arranged so as to be conjugated to the third optic 19, the fourth optic 23 and the fifth optic 24 by means of the splitter element 10.

Furthermore, the third diaphragm 25 is arranged in a focal plane of the third optic 19 by means of the splitter element 10, for example in an image focal plane of the third optic 19. Thus, the third diaphragm 25 is conjugated to the reflection surface 6 by means of the first objective 20 (the reflection surface 6 being at one of the foci of the first objective 20, for example at the secondary focus of the first objective 20).

Furthermore, the third diaphragm 25 is arranged in a focal plane of the fourth optic 23 by means of the splitter element 10. For example, the third diaphragm 25 is arranged in the image focal plane of the fourth optic 23 by means of the splitter element 10.

Furthermore, the third diaphragm 25 and the optical sensor are conjugated (by means of the fifth optic 24).

It is noted that with the configuration described, the source 5 is “imaged” (i.e. an enlarged image thereof is created at the first diaphragm 16). This magnification is generated by the pair composed of the second optic 15 and the third optic 23.

This makes it possible to reduce the divergence of the rays generated by the source 5 and/or to reduce an illumination numerical aperture generated by the source 5.

However, it should be ensured that the magnification, generated by the pair composed of the second optic 15 and the third optic 23, of the image of the source 5 is not greater than the dimensions of a pupil of the user at the object focal plane of the first objective 20 and the second objective 21.

This makes it possible to preserve the incoherent (or poorly coherent) nature of the source 5 and/or to limit any loss of power in the light radiation generated by the source 5.

Preferably, the focal length(s) of the first optic 14 is/are thus selected depending on the divergent nature of the source 5, the distance between the source 5 and each of the objectives 20, 21, and the dimensions of a pupil of a user at the object focal planes of the objectives 20, 21.

Furthermore, the first diaphragm 16 is conjugated, by means of the second optic 15 and the pair composed of the third optic 19 and the fourth optic 23, to focal planes of the objectives 20, 21, for example to object focal planes of the objectives 20, 21.

In addition, the fourth optic 23 makes it possible to image the second diaphragm 17 on the sample. Preferably, the second diaphragm 17 is placed at the focal distance of the second optic 15.

The configuration described is thus a practical application of the principle of Koehler illumination.

It is clear that the relative position of the second objective 21 with respect to the source 5 and the reflection surface 6 is critical. When the microscope 2 is coupled to the module 3, the optical axis of the second objective 21 is in fact in a fixed position relative to the working axis of the module 3. Nevertheless, the two adjustment units 11, 18 allow the source 5 and the reflection surface 6 to be positioned correctly with respect to the second objective 21, in particular so that interference can be generated between the reference waves and the object waves.

In particular, the reflection surface 27 is configured (owing to its relative movement with respect to the frame) for aligning the group composed of the splitter element 10, third optics 19, reflection surface 18 and first objective 20 with the group composed of the splitter element, fourth optics 23, reflection surface 22 and second objective.

The module 3 is thus inserted into the microscope 2 in a simple manner, and then the characteristics of the module 3 are adjusted using the two adjustment units 11, 18 in order to optically align the module 3 and the microscope 2. By way of example, the adjustment unit 18 (comprising in particular the movement member 26) is used to make the reference arm identical to the object arm (on which it is more difficult to act given that the distance between the second objective 21 and the optical output of the microscope 2 is fixed), and the adjustment unit 11 is used to modify the illumination arm, if necessary, in order to align the working axis of the module 3 with the propagation axis of the source 5.

Owing to the adjustment units 11, 18, the module 3 can thus be connected to various microscopes on the market.

The assembly 1 thus described is an improvement to a Linnik interferometer in a Koehler illumination configuration.

In the assembly 1 thus described, the splitter element 10 is much further away from the two objectives 20, 21 than in the prior art systems. This advantageously allows the module 3 to be coupled to a conventional microscope. It also makes it possible to use objectives (both the first objective 20 and the second objective 21) having greater numerical apertures.

Furthermore, the presence of at least one optic downstream of the splitter element 10, on the object arm side, makes it possible to improve the quality of the images derived from the signals generated in the assembly 1. In particular, with this configuration, the incoherent reflections are reduced by the third diaphragm 25 and then spatially confined to the centre of an acquisition surface of the optical sensor (when said acquisition surface is centred with respect to an axis normal to a splitting surface of the splitter element). It is therefore easier for the processing device 8 to separate said incoherent reflections from the coherent reflections and thus to obtain a better-quality image.

Starting from the described assembly 1, it is possible to perform both static full-field optical coherence tomography imaging and dynamic full-field optical coherence tomography imaging.

In the case of dynamic full-field optical coherence tomography imaging, a sample is placed in the microscope 2 and a temporal sequence of N two-dimensional interferometric signals from a portion of the sample is acquired by the acquisition device 7, with a fixed path difference between the object arm and the reference arm. For example, the path difference is maintained by holding both the reflection surface 6 and the sample in a fixed position. To this end, the processing device 8 is, in this case, configured to synchronise the acquisition device 7 (in particular its optical sensor) with the actuator for moving the reflection surface 6. By way of example, in addition to a computer, the processing device 8 may also comprise an acquisition card connected to the computer to ensure said synchronisation.

In addition, it is possible to perform full-field optical coherence tomography imaging either with the incubator or without the incubator.

Consequently, the described assembly allows numerous imaging possibilities to be implemented.

Owing to the described assembly 1, it is possible, for example, to acquire images of cells but also to visualise cell activity and discern the metabolic state of a cell. The cells can, for example, be two-dimensional cultures such as two-dimensional monolayer cultures, three-dimensional cultures such as organoids, or other three-dimensional multilayer cultures, etc.

Specifically, it is possible to study the cells invasively but non-destructively. One of the strengths of described assembly 1 is therefore its ability to create images without disturbing the natural environment. The assembly 1 thus described can be used, for example, to study organoids, two-dimensional monolayer cultures, three-dimensional multilayer cultures, retinas and corneas, retina and cornea explants from mice, pigs, macaques, etc., to perform quality control on large-scale organoid production, to assist with the fields of microfluidics, optogenetics (for example by photo-stimulation for optophysiology) and disease modelling, to test the efficacy of new treatments (genetics, pharmaceuticals, etc.), for transplants, etc.

Furthermore, the described assembly 1 makes it possible to generate both a static signal for visualising the structure of a tissue in three dimensions, and a dynamic signal for identifying the cells of a tissue and measuring their metabolism, for example.

Other applications of the described assembly 1 may be envisaged, for example all microscopy studies with high spatial resolution (for example a resolution between 100 and 400 nanometres) and/or temporal resolution (for example a resolution in the millisecond range, for example 2 milliseconds), in particular those in which the sample is not destroyed and/or the absence of endogenous markers is incorporated.

In addition, it is possible to create real-time tracking of a sample by, for example, generating an image having a contrast that reflects movement mechanisms of around X milliseconds, X being between 100 and 200 milliseconds, X being, for example, 160 milliseconds.

It goes without saying the invention is not limited to the described embodiment but covers any variant falling under the scope of the invention as defined by the claims.

In particular, the incubator may or may not be part of the assembly and/or the acquisition device may or may not be part of the assembly and/or the processing device may or may not be part of the assembly and/or the source may or may not be part of the assembly.

In addition, the acquisition device may or may not be part of the module and/or the processing device may or may not be part of the module and/or the source may or may not be part of the module.

The module could comprise one or more glass plates to limit dispersion phenomena.

Where the microscope used is not provided with a planar reflection surface between its objective and an optical output, the microscope could of course be equipped with such a planar surface. For example, a planar reflection surface of this kind could be arranged in the module between the fourth optic and the working output of the module, or a planar surface of this kind could be arranged in another module which is itself inserted into one of the banks of the microscope so as to be associated with the invention.

Although in this case the module is coupled to the microscope by simply inserting the module into the microscope, the module and the microscope could, in addition or alternatively, be coupled together through the interaction of a male connector and a female connector, the two connectors being capable of interacting in order to connect the module to the microscope. By way of example, the module could comprise a male connector and the microscope a female connector. For example, the module comprises a threaded rod capable of being screwed into a corresponding threaded orifice in the microscope.

The microscope of the assembly could be a microscope without a turret.

The microscope of the assembly need not be an inverted microscope. The sample could thus be illuminated from above (in which case the second objective then also picks up the signal from above) as well as from below (in which case the second objective preferably picks up the signal from below as well).

The third optic might not be present. The third optic could be included in the microscope rather than in the module.

The optical sensor could be different from that specified, for example the optical sensor could be a charge-coupled device (CCD) sensor. The optical sensor could be capable of working in the visible range and/or in another range, such as infrared. The optical sensor could thus be a near-infrared image sensor (or a Short-Wave-Infrared sensor, SWIR). By way of example, the optical sensor could be an InGaAs (indium gallium arsenide) sensor or an InGaAs SWIR sensor. The module and/or the assembly could be shaped so that the optical sensor (and/or the acquisition device) is interchangeable in order, for example, to be able to work in the visible range and then to be able to work in a range other than the visible range, for example infrared.

The assembly might not comprise an incubator (whether portable or not). The assembly could comprise a heating chamber in which at least the microscope is arranged so as to be able, for example, to keep the sample at a given temperature.

Although the optics in this case all have lenses having at least one planar face, the lenses could be shaped differently. Moreover, the lenses could have a different orientation from that specified. Preferably, a lens is arranged in the module so that the light beam having the largest aperture angle (between the incoming or outgoing light beam) is associated with the most planar face of the lens.

Although high-numerical-aperture objectives have been used here, objectives having a lower numerical aperture could of course also be used.

1. Module intended to be associated with a microscope for full-field optical coherence tomography microscopic imaging of at least one sample, the module comprising an interference device comprising a non-polarising beam splitter element, the device further comprising at least one first reflection surface, the device thus being capable, during operation, of allowing at least one interference to be produced between:
at least one reference wave obtained by reflecting the light emitted by a light source associated with the module on the reflection surface and
at least one object wave obtained by backscattering the light emitted by said source onto the sample,
the non-polarising beam splitter element thus making it possible, during operation, when it is illuminated by the source, to form two arms, namely a “reference arm” associated with the reflection surface and an “object arm” associated with the sample, the device further comprising:
a first adjustment unit arranged upstream of the non-polarising beam splitter element for allowing an illumination arm of the non-polarising beam splitter element to be modified during operation, and/or
at least one second adjustment unit arranged between the beam splitter element and the reflection surface for allowing the reference arm to be modified during operation.

2. Module according to claim 1, wherein the first adjustment unit comprises at least two reflection surfaces, at least one of said reflection surfaces being movable relative to a frame of the module.

3. Module according to claim 1, comprising an objective associated with the reference arm, the second adjustment unit comprising at least one additional reflection surface and at least one member for moving said objective relative to a frame of the module.

4. Module according to claim 3, wherein the additional reflection surface is also movable relative to a frame of the module.

5. Module according to claim 3, wherein the movement member is configured to move the objective at least in a plane parallel to the plane in which the first reflection surface extends.

6. Module according to claim 1, wherein the source is part of the module.

7. Module according to claim 1, comprising an acquisition device suitable for acquiring at least one signal resulting from the interference between the reference waves and the object waves.

8. Module according to claim 1, wherein the interference device comprises an optic arranged between the splitter element and a module output intended to be at least optically coupled to the microscope.

9. Assembly comprising a microscope and a module according to claim 1.

10. Assembly according to claim 9, wherein the microscope comprises a turret, the module being arranged in one of the compartments of the turret.

11. Assembly according to claim 9, comprising an incubator supported by a stage of the microscope.
